(19) United States
(12) Patent Application Publication
(10) Pub. No.: US 2024/0023357 A1
(43) Pub. Date: Jan. 18, 2024

(54) QUANTUM DOT AND METHOD FOR PREPARING THE SAME

(71) Applicant: National Tsing Hua University, Hsinchu City (TW)

(72) Inventors: Chang-Wei YEH, Taoyuan City (TW); Hsueh-Shih CHEN, Hsinchu City (TW); Yuan CHEN, New Taipei City (TW)

(21) Appl. No.: 18/068,974

(22) Filed: Dec. 20, 2022

(30) Foreign Application Priority Data
Jul. 12, 2022 (TW) 111126034

(51) Int. Cl. H10K 50/115; H10K 71/40; C09K 11/88

(52) U.S. Cl. CPC H10K 50/115; H10K 71/441; C09K 11/881; C09K 11/883; B82Y 30/00

(57) ABSTRACT

A quantum dot includes a nanocrystalline core and a nanocrystalline shell. The nanocrystalline core includes a core body and a doping material that is non-uniformly doped in the core body. The core body has a sphalerite-type crystal structure, and includes at least one element from Group IB, at least one element from Group IIIA and at least one element from Group VIA. The doping material includes at least one doping element selected from the group consisting of an element from Group IB, an element from Group IIB and an element from Group IIIA. The nanocrystalline shell surrounds the nanocrystalline core and includes at least one element from Group VIA, and at least one element from one of Group IIB and Group IIIA. A method for preparing the quantum dot is also disclosed.

### CROSS-REFERENCE TO RELATED APPLICATION

This application claims priority of Taiwanese Invention Patent Application No. 111126034, filed on Jul. 12, 2022.

### FIELD

The disclosure relates to a quantum dot and a method for preparing the same, and more particularly to a quantum dot having a core-shell structure and a method for preparing the same.

### BACKGROUND

Quantum dots are characterized by their nanometer size. Quantum dots are excited by light or electricity can emit light of different wavelengths depending on the band gap energy thereof which can be adjusted by varying their sizes and compositions. Hence, quantum dots are widely studied in recent years, and have been applied in various devices, such as light-emitting devices, sensing devices, solar cells, and biomedical devices.

Although cadmium (Cd)-based quantum dots that are commonly used in the art have advantages, such as high photoluminescence quantum yields (PLOY), being capable of emitting light of all visible wavelengths, and having narrow full width at half maximum (FWHM), Cd element is highly toxic and is a cancer risk factor. Therefore, those skilled in the art dedicate to develop a quantum dot that are free of cadmium and still has a high PLOY. Since conventional group semiconductor quantum dots (e.g., CuInSe₂ and AgInS₂) have the benefits of being non-toxic, good stability, high extinction coefficients, etc., such semiconductor quantum dots have received widespread attention. However, the conventional group semiconductor quantum dots (e.g., CuInSe₂) still have low quantum conversion efficiency.

In Juan Yang et al., NANO: Brief Reports and Reviews, Vol. 14, No. 6, (2019) 1950070, a low-temperature synthetic scheme is provided to prepare ZnCuInSe/ZnSe quantum dots. Briefly, a precursor solution containing a salt of indium (In), a salt of zinc (Zn), and a salt of copper (Cu) was mixed with a thiol reagent (i.e., 1-dodecanethiol (DDT)) and oleylamine (OAm) to form Cu—In—(S—R)ₓ—(NH₂—R)_{y} clusters, followed by swiftly injecting a TOPSe stock solution (selenium (Se) precursor) to replace sulfur (S) of Cu—S and In—S with Se, thereby forming a CuInSe-based core. Afterwards, Zn-doping and ZnSe coating are simultaneously carried out. The as-synthesized ZnCuInSe/ZnSe core-shell quantum dots exhibited enhanced PLQY of 65% at wavelength of 670 nm which can be attributed to the sufficient displacement of In atoms by Zn atoms. In addition, Juan Yang et al. also showed that the ZnCuInSe core of the ZnCuInSe/ZnSe quantum dots have a tetragonal (chalcopyrite-type) crystal structure despite of incorporation of Zn atoms, and zinc (Zn) ions were uniformly distributed in the ZnCuInSe core.

### SUMMARY

Therefore, an object of the disclosure is to provide a quantum dot and a method for preparing the same that can alleviate at least one of the drawbacks of the prior art.

According to the disclosure, the quantum dot includes a nanocrystalline core and a nanocrystalline shell.

The nanocrystalline core includes a core body and a doping material that is non-uniformly doped in the core body. The core body has a sphalerite-type crystal structure, and includes at least one element from Group IB, at least one element from Group IIIA and at least one element from Group VIA. The doping material includes at least one doping element selected from the group consisting of an element from Group IB, an element from Group IIB and an element from Group IIIA.

The nanocrystalline shell surrounds the nanocrystalline core and includes at least one element from Group VIA, and at least one element from one of Group IIB and Group IIIA.

According to the disclosure, the method includes the steps of:
a) preparing a first solution which includes a salt of at least one element from Group IB, a salt of at least one element from Group IIIA, and a first coordinating solvent, preparing a second solution which includes at least one element from Group VIA, and a second coordinating solvent, and preparing a third solution which includes a salt of at least one doping element selected from the group consisting of an element from Group IB, an element from Group IIB and an element from Group IIIA, and a third coordinating solvent;
b) heating the first solution to a reaction temperature ranging from 160° C. to 220° C., and reacting therewith the second solution at the reaction temperature to obtain a nucleated solution, followed by heating the nucleated solution to a temperature ranging from 160° C. to 240° C., so as to obtain a crystallized solution;
c) adding a thiol reagent into the crystallized solution for reaction to proceed at a temperature ranging from 180° C. to 200° C., so as to obtain an intermediate reaction solution; and
d) adding the third solution into the intermediate reaction solution at a temperature ranging from 180° C. to 200° C., so as to obtain a solution containing the quantum dot.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view illustrating a structure of an embodiment of a quantum dot according to the disclosure.

FIG. 2 is a flowchart illustrating a method for preparing the quantum dot according to the disclosure.

FIG. 3 is a high resolution transmission electron microscope (HRTEM) image illustrating a structure of a quantum dots of Example 1 (E1).

FIG. 4 is a HRTEM image illustrating a structure of a quantum dots of Comparative Example 1 (CE1).

FIG. 5 is a plot showing a photoluminescence (PL) spectrum and an ultraviolet-visible (UV-vis) absorption spectrum of the quantum dots of E1.

FIG. 6 is a plot showing a PL spectrum and an UV-vis absorption spectrum of the quantum dots of Example 2 (E2).

FIG. 7 is a plot showing PL spectra of the quantum dots of Example 3 (E3) to Example 5 (E5).

FIG. 8 is a plot showing a PL spectra of the quantum dots of Example 6 (E6) to Example 9 (E9).

FIG. 9 is a plot showing a PL spectrum and an UV-vis absorption spectrum of the quantum dots of Comparative Example 1 (CE1).

FIG. 10 is a plot showing a PL spectrum and an UV-vis absorption spectrum of the quantum dots of Comparative Example 2 (CE2).

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

For the purpose of this specification, it will be clearly understood that the word “comprising” means “including but not limited to”, and that the word “comprises” has a corresponding meaning.

Unless defined otherwise, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

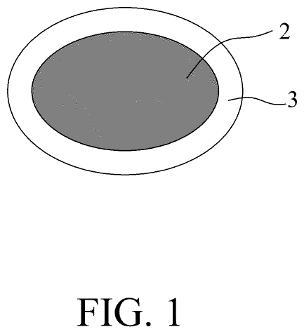

Referring to FIG. 1, an embodiment of a quantum dot of this disclosure includes a nanocrystalline core 2 and a nanocrystalline shell 3.

The nanocrystalline core 2 includes a core body and a doping material that is non-uniformly doped in the core body. The core body has a sphalerite-type crystal structure, and includes at least one element from Group IB, at least one element from Group IIIA, and at least one element from Group VIA. The doping material includes at least one doping element that is selected from the group consisting of an element from Group IB, an element from Group IIB, and an element from Group IIIA.

The nanocrystalline shell 3 surrounds the nanocrystalline core 2, and includes at least one element from Group VIA, and at least one element from one of Group IIB and Group IIIA. For example, the nanocrystalline shell 3 may include an element from Group VIA and an element from Group IIB, or may include an element from Group VIA and an element from Group IIIA. The nanocrystalline shell 3 may have a sphalerite-type crystal structure.

In certain embodiments, the core body is represented by a formula of CuInSeₓS₂₋ₓ and the nanocrystalline shell 3 is represented by a formula of ZnSe_{y}S_{1-y}, wherein 0≤x≤2 and 0≤y≤1.

The nanocrystalline core 2 may have a particle size within a range of 3 nm to 8 nm, and the nanocrystalline shell 3 may have a thickness within a range of 0.3 nm to 3 nm. In certain embodiments, the core body includes a doped region that is doped by the doping material and that has a depth measured from an outer surface of the core body. The depth of the doped region may be not less than 30% of a radius of the core body.

In certain embodiments, the doping material include a doping element from Group IIB (such as Zn) which is present in an atomic percentage ranging from 1% to 50% in the nanocrystalline core 2. In an exemplary embodiment, the doping element from Group IIB is present in an atomic percentage ranging from 1% to 40%, such as 3% to 31% in the nanocrystalline core 2. The quantum dot may have a photoluminescence wavelength that is not less than 700 nm and a photoluminescence quantum yield (PLQY) that is greater than 70%. In an exemplary embodiment, the quantum dot has a photoluminescence wavelength that is not less than 750 nm and a PLQY that is greater than 80%.

In other embodiments, the doping material include a doping element from Group IB (such as Ag) and/or a doping element from Group IIB (such as Zn), and the doping element from Group IB is present in an atomic percentage ranging from 1% to 10% in the nanocrystalline core 2. The quantum dot may have a photoluminescence wavelength that is greater than 1000 nm and a photoluminescence quantum yield that is greater than 50%.

In yet other embodiments, the doping material include at least one doping element from Group IIIA, and the nanocrystalline shell 3 is represented by a formula of GaₐS_{b} or by a formula of InₐS_{b}, wherein 0≤a≤2 and 0≤b≤3.

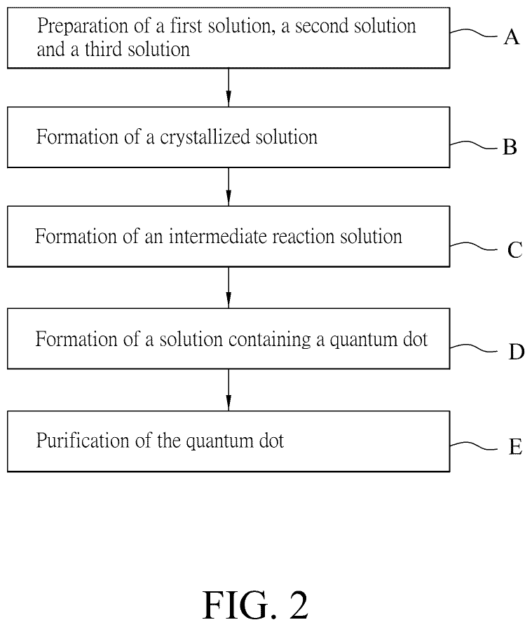

Referring to FIG. 2, a method for preparing the abovementioned quantum dot includes following consecutive steps.

In step A, a first solution, a second solution and a third solution are respectively prepared by heating the components as described below at a temperature ranging from 80° C. to 150° C., a temperature ranging from 60° C. to 100° C., and a temperature ranging from 80° C. to 150° C., respectively, under an atmosphere of an inert gas. The first solution includes a salt of at least one element from Group IB, a salt of at least one element from Group IIIA, such as indium(III) acetate (In(OAc)₃) and indium chloride, and a first coordinating solvent. The salt of at least one element from Group IB may be copper(I) iodide (CuI), but is not limited thereto. The salt of at least one element from Group IIIA may be indium(III) acetate (In(OAc)₃) and/or indium chloride, but is not limited thereto. The second solution includes at least one element from Group VIA, and a second coordinating solvent. The third solution includes a salt of at least one doping element selected from the group consisting of an element from Group IB, an element from IIB and an element from Group IIIA, and a third coordinating solvent. The salt of at least one doping element may be zinc acetate (Zn(OAc)₂) and/or zinc chloride, but is not limited thereto.

Each of the first coordinating solvent, the second coordinating solvent and the third coordinating solvent may independently include, but is not limited to, a thiol having 8 to 16 carbon atoms such as 1-dodecanethiol (DDT); an fatty acid having 12 to 18 carbon atoms such as oleic acid; a fatty amine having 12 to 18 carbon atoms such as oleylamine (OLA); an organophosphate such as diphenylphosphine (DPP) and trioctylphosphine (TOP); and combinations thereof.

At least one of the first solution, the second solution and the third solution may further include a non-coordinating solvent. Examples of the non-coordinating solvent may include, but are not limited to, 1-octadecene (ODE), paraffin oil, and a combination thereof.

The element from Group IB may be selected from copper (Cu), silver (Ag), and gold (Au). The element from Group IIB may be zinc (Zn). The element from Group IIIA may be selected from aluminum (Al), gallium (Ga), and indium (in). Examples of the inert gas may include, but are not limited to, nitrogen gas (N₂), argon gas (Ar), helium gas (He) and combinations thereof.

In step B, the first solution is heated to a reaction temperature ranging from 160° C. to 220° C. to become clear, followed by reacting therewith the second solution at the reaction temperature for a predetermined time period to proceed with nanocrystal nucleation, so as to obtain a nucleated solution. Subsequently, the nucleated solution is heated to a temperature ranging from 160° C. to 240° C. for a predetermined time period to proceed to nanocrystal growth, so as to obtain a crystallized solution which includes the core body.

In step C, to the crystallized solution that is kept at a temperature ranging from 180° C. to 200° C., a thiol reagent is added for a predetermined time period, so as to obtain an intermediate reaction solution. Such addition may be in a continuous manner or in a dropwise manner, but is not limited thereto.

In certain embodiments, the thiol reagent is added at an addition rate that is not greater than one tenth of a total amount of the thiol reagent added in step c) per minute, so as to avoid excess addition of the thiol reagent per unit time to form an undesired shell layer that may affect the distribution of the doping material. For example, the thiol reagent may be added at the addition rate ranging from 0.2 mL/min to 0.5 mL/min.

In other embodiments, the second solution includes a first sub-solution which includes the element from Group VIA in a first concentration and a second sub-solution which includes the element from Group VIA in a second concentration different from the first concentration. In such case, in step B, the first sub-solution of the second solution may be added to react with the heated first solution, and in step C, the second sub-solution of the second solution and the thiol reagent may be simultaneously added to the crystallized solution for reaction to proceed. The second sub-solution and the thiol reagent may be simultaneously added in a continuous manner or in a dropwise manner, but is not limited thereto.

In step D, the third solution is added into the intermediate reaction solution at a temperature ranging from 200° C. to 220° C. for reaction to proceed for a predetermined time period (such as 150 to 250 mins) so as to form the nanocrystalline shell 3 surrounding the nanocrystalline core 2, thereby obtaining a solution containing the abovementioned quantum dot.

In certain embodiments, the third solution is added in a stepwise manner with a time interval not shorter than 30 minutes. It should be noted that when the third solution is added too fast, the third solution does not have enough time to react with the intermediate reaction solution, and thus the nanocrystalline shell 3 may grow too rapidly to form a nanocrystalline grain with a large particle size. In such case, the distribution of the doping element in the core body may be hindered and the structural transformation of the core body due to the incorporation of the doping element therein may be hard to proceed. Therefore, in an exemplary embodiment, the third solution is stepwise added into the intermediate reaction solution at least three times, with a time interval ranging from 30 minutes to 60 minutes.

In step E, the abovementioned quantum dot is purified from the solution obtained in step D.

In certain embodiments, the step E is conducted by naturally cooling down the solution obtained in step D to room temperature, followed by adding a participating solution there.

The participating solution may be a mixture of ethanol and acetone. In an exemplary embodiment, the mixture of ethanol and the acetone is in a volume ratio of 1:1.

By reacting the crystallized solution containing the core body (such as a Group I-III-VI-based core body) obtained in step B with the thiol reagent in step C, the rate for forming the nanocrystalline shell 3 from the third solution in step D can be slowed down, and the doping element of the third solution is allowed to have more time to diffuse into and distribute in the core body (i.e., extended doping time). As a result, the doping material may be non-uniformly doped in the core body (e.g., at defect sites of the core body), and may even reach a deeper region of the core body.

Moreover, by adding the thiol reagent before forming the nanocrystalline shell 3, the nanocrystalline shell 3 can be formed as a sphalerite-type (cubic) crystal structure. In addition, the atoms of the doping material diffuse into the core body, and thus trigger sub-movement of the atom(s) in the core body, causing a crystal structure of the core body transforming from an initial chalcopyrite type (tetragonal) to a sphalerite type (zinc blende), so that the core body of the quantum dot of this disclosure has a sphalerite-type crystal structure.

It should be noted that a conventional Group I-III-VI-based quantum dot (e.g., CuInS and CuInSe) has a chalcopyrite-type (tetragonal) crystal structure, and carrier recombination pathways are generated by point (zero-dimensional) defects. In Juan Yang et al., supra, by introducing a doping material (e.g., Zn), sufficient In defect sites can be replaced by Zn atoms, so that the resultant ZnCuInSe quantum dot has a tetragonal crystal structure and enhanced photoluminescence quantum yields (PLQYs). However, by virtue of the method of the present disclosure, the structure of the core body can be transformed from a chalcopyrite-type (tetragonal) crystal structure to a sphalerite-type (cubic) crystal structure. Since the replacement of the doping material in the cubic crystal structure is easier than that in the tetragonal crystal structure, the doping material may diffuse into the core body to fill vacancy and replace the In and Cu sites. Therefore, the PLQYs of the quantum dot of this disclosure which may have Zn replacement at In and Cu sites and Cu replacement at In sites and/or In replacement at Cu sites, can be more effectively enhanced.

The disclosure will be further described by way of the following example. However, it should be understood that the following examples are solely intended for the purpose of illustration and should not be construed as limiting the disclosure in practice.

### EXAMPLES

### Example 1 (E1). Zn:CuInSeS/ZnS Quantum Dot

### Preparation of Precursor Solutions

1. First Solution (in-Containing Precursor and Cu-Containing Precursor):

1 mmol copper(I) iodide (CuI), 1 mmol indium(III) acetate (In(OAc)₃), 2.5 mL 1-dodecanethiol (DDT), 0.5 mL oleylamine (OLA), and 3 mL 1-octadecene (ODE) were mixed and degassed under vacuum for 30 minutes. After bubbling with nitrogen gas (N₂) for 15 minutes, the resultant mixture was heated to 120° C. and degassed for 15 minutes, so as to obtain a first solution.

2. Second Solution (Se-Containing Precursor):

1 mmol selenium (Se) powder, 0.75 mL OLA, and 0.25 mL DDT were mixed, followed by heating to 80° C., so as to obtain a second mixture.

3. Third Solution (Zn-Containing Precursor):

5 mmol zinc acetate (Zn(OAc)₂), 3.15 mmol oleic acid (OA), and 6.85 mL ODE were mixed and heated to 120° C., and then degassed under vacuum for 30 minutes. After bubbling with nitrogen gas (N₂) for 15 minutes, the resultant mixture was degassed at 120° C. for 15 minutes, so as to obtain a third solution.

### Preparation of Quantum Dots

The first solution was heated to a reaction temperature of 180° C. under a nitrogen atmosphere, and then the second solution was injected into the heated first solution at 180° C. to proceed to allow a reaction of Cu—In—Se—S nanocrystal nucleation to proceed for 10 minutes. The resultant nucleated solution was heated to 230° C. for 15 minutes to allow nanocrystal growth, so as to obtain a crystallized solution containing a Cu—In—Se—S core body.

Subsequently, the crystallized solution was cooled down to 200° C., followed by injecting thereinto 2.5 mL DDT at an addition rate of 0.25 ml/min, so as to obtain an intermediate reaction solution.

Afterwards, the third solution (10 mL) was divided into four equal parts (i.e., 2.5 mL per part) which were stepwise added into the intermediated reaction solution at 200° C., with a time interval of 50 minutes for Zn incorporation and ZnS shell formation (a total reaction time is 200 minutes), so as to obtain a solution containing a Zn:CuInSeS/ZnS quantum dot.

After the thus obtained solution containing the Zn:CuInSeS/ZnS quantum dot was cooling down to room temperature, a participating solution (a mixture of ethanol and acetone in a volume ratio of 1:1) is added to precipitate the Zn:CuInSeS/ZnS quantum dot out from the solution, followed by filtration. The aforesaid processes may be repeated again after the filtrated product is dispersed into toluene, so as to obtain a purified Zn:CuInSeS/ZnS quantum dot of E1 which was determined to have a particle size of about 7.38±1.3 nm.

The Zn:CuInSeS/ZnS quantum dot of E1 was determined by an energy dispersive spectrometer (EDS) to have an atomic percentage of Zn of 31.6%, suggesting that Zn was theoretically doped in an atomic percentage of 8.2% in the nanocrystalline core 2.

### Example 2 (E2). Zn:CuInSeS/ZnSeS Quantum Dot

### Preparation of Precursor Solutions:

The quantum dot of E2 was prepared by procedures generally similar to those of E1, except for the following differences.

To be specific, the second solution (Se-containing precursor) used in E2 includes a first sub-solution containing Se in a first concentration and a second sub-solution containing Se in a second concentration that is different from the first concentration. To be specific, the first sub-solution is prepared by mixing 1 mmol selenium (Se) powder, 0.75 mL OLA, and 0.25 mL DDT, followed by heating to 80° C. The second sub-solution was prepared by mixing 2 mmol selenium (Se) powder, 3.0 ml OLA, and 2 ml diphenylphosphine (DPP) at room temperature.

In addition, the first sub-solution was injected into the heated first solution at the reaction temperature to proceed to allow a reaction of nanocrystal nucleation to proceed, so as to obtain the crystallized solution. Then, the thiol reagent and the second sub-solution were simultaneously and continuously added, at addition rates of 0.25 mL/min and 0.5 mL/min, respectively, into the crystallized solution, so as to obtain an intermediate reaction solution. The thus obtained Zn:CuInSeS/ZeSeS quantum dot of E2 was determined to have a particle size of about 7.28±0.9 nm, and has the atomic percentage of Zn of 27.3% as measured by EDS, suggesting that Zn was theoretically doped in an atomic percentage of 3.9% in the nanocrystalline core 2.

### Example 3 to 5 (E3 to E5). Zn:CuInSeS/ZnS Quantum Dot

The quantum dots of E3 to E5 were prepared by procedures generally similar to those of E1, except that before adding the second solution into the first solution, 0.25 mmol, 0.5 mmol, and 1.0 mmol of zinc acetate (Zn(Ac)₂) degassed at 120° C. were first added into the first solutions in E3 to E5 respectively, and then the second solution was added into the resultant mixture.

Therefore, the obtained quantum dots of E3 to E5 were similar to that of E1, except for different doping concentration of Zn. That is, the quantum dots of E3 to E5 were respectively prepared using a ratio of Zn to Cu of 0.25, 0.5 and 1.0, and may theoretically respectively have Zn doped in an atomic percentage of 13%, 19%, and 31% in the nanocrystalline core 2 based on the data measured by EDS.

### Example 6 to 8 (E6 to E8). Ag/Zn:CuInSeS/ZnS Quantum Dot

The quantum dots of E6 to E8 were prepared by procedures generally similar to those of E1, except that before adding the second solution into the first solution, 0.1 mmol, 0.2 mmol, and 0.5 mmol of silver acetate (AgAc) were respectively added into the first solutions in E3 to E5, and then the second solution was added into the resultant mixture.

Therefore, the thus obtained quantum dots of E6 to E8 were Ag/Zn:CuInSeS/ZnS quantum dots doped with Ag and Zn. That is, the quantum dots of E6 to E8 were respectively prepared using a ratio of Ag to Cu of 0.1, 0.2 and 0.5, and may theoretically respectively have the Ag doped in an atomic percentage of 5%, 9%, and 18% in the nanocrystalline core 2, based on the data obtained by EDS.

### Comparative Example 1 (CE1). CuInSeS Quantum Dot

### Preparation of Precursor Solutions

1. First Solution (in-Containing Precursor and Cu-Containing Precursor):

1 mmol copper(I) iodide (CuI), 1 mmol indium(III) acetate (In(OAc)₃), 2.5 mL dodecanethiol (DDT), 0.5 mL oleylamine (OLA), and 3 mL 1-octadecene (ODE) were mixed and degassed under vacuum for 30 minutes. After bubbling with nitrogen gas (N₂) for 15 minutes, the resultant mixture was heated to 120° C. for 15 minutes, so as to obtain a first solution.

2. Second Solution (Se-Containing Precursor):

1 mmol selenium (Se) powder, 0.75 mL OLA, and 0.25 mL DDT were mixed, followed by heating to 80° C., so as to obtain a second mixture.

### Preparation of Quantum Dots

The first solution was heated to a reaction temperature of 180° C. under a nitrogen atmosphere, and then the second solution was injected into the heated first solution at 180° C. to allow a reaction of Cu—In—Se—S nanocrystal nucleation to proceed for 10 minutes. The resultant nucleated solution was heated to 230° C. for 15 minutes to allow nanocrystal growth, so as to obtain a crystallized solution containing a Cu—In—Se—S quantum dot.

After cooling down the thus obtained solution containing the Cu—In—Se—S quantum dot to room temperature, a participating solution (mixture of ethanol and acetone in a volume ratio of 1:1) is added to precipitate the Cu—In—Se—S quantum dot out from the solution, followed by filtration. The aforesaid processes may be repeated again after the filtrated product is dispersed in toluene, so as to obtain a purified Cu—In—Se—S quantum dot of CE1 which was determined to have a particle size of about 7.51±1.0 nm. The thus obtained Cu—In—Se—S quantum dot was then dispersed in toluene to form a dispersion, which used for the following analyses.

### Comparative Example 2 (CE2). CuInSeS/Zn Quantum Dot

### Preparation of Precursor Solutions

The quantum dot of CE2 was prepared by procedures generally similar to those of CE1, except for the following differences. To be specific, the precursor solutions in this example were similar to those in E1, except that the first solution used in CE2 had no DDT, and a third solution (Zn-containing precursor) was further prepared as follows. That is, 5 mmol zinc acetate (Zn(Ac)₂), 5 mmol oleylamine (OLA), and 5 mL ODE were mixed and heated to 120° C., and then degassed under vacuum for 30 minutes. After bubbling with nitrogen gas (N₂) for 15 minutes, the resultant mixture was degassed for 15 minutes, so as to obtain the third solution.

### Preparation of Quantum Dot

In addition, the thus obtained crystallized solution was added into the third solution, and then a thiol reagent (DTT) was added thereinto, at an addition rate of 0.25 mL/min at 200° C. to allow the reaction to proceed, thereby obtaining a solution containing a CuInSeS/ZnS quantum dot of CE2.

### Characterization of Quantum Dots

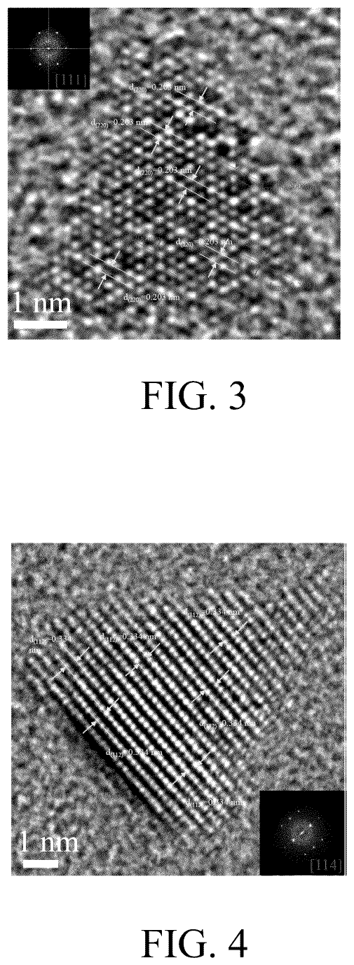

The structure of each of the quantum dots of E1 and CE1 was analyzed using a transmission electron microscope (TEM), and the results are shown in FIGS. 3 and 4.

Referring to FIG. 3, a top-left corner view is the diffraction (selected area diffraction (SAD)) pattern of the quantum dot of E1 which shows that no impurities are present around the diffraction points of the diffraction pattern, indicating that the crystal structures of the nanocrystalline shell 3 and the nanocrystalline core 2 of the quantum dot of E1 were the same. That is, both of the nanocrystalline core 2 and the nanocrystalline shell 3 of the Zn:CuInSeS/ZnS quantum dot in E1 have a sphalerite-type crystal structure, which is different from the tetragonal crystal structure of CE1 which will be discussed later.

In addition, the atomic distance (d₍₂₂₀₎) measured at different sites (from the surface to the center) of the nanocrystalline core 2 in E1 was mainly nm, which was consistent with the atomic distance of CuInSe (cubic crystal structure) quantum dots (d₍₂₂₀₎=0.203 nm). On the other hand, other atomic distance (d₍₂₂₀₎=0.200 nm) was measured at some different sites of the nanocrystalline core 2, indicating that the core body of the quantum dot of E1 was doped with Zn²⁺ at some sites, causing a partial lattice distortion. Moreover, by observing the differences of the atomic distances at different sites, the doping elements (Zn) were non-uniformly doped in a doped region of the core body, in which the doped region has a depth (measured from an outer surface of the core body) that is not less than 30% of a radius of the core body.

Referring to FIG. 4, the CuInSeS quantum dot of CE1 has the diffraction pattern of a chalcopyrite type (tetragonal) crystal structure, and has an interplanar spacing of (112) plane (d₍₁₁₂₎) being 0.334 nm, which is substantially the same as those of the CuInSe quantum dot (tetragonal crystal structure, d₍₁₁₂₎=0.33 nm) and the ZnCuInSe quantum dot (tetragonal crystal structure, d₍₁₁₂₎=0.33 nm) in Juan Yang et al., supra.

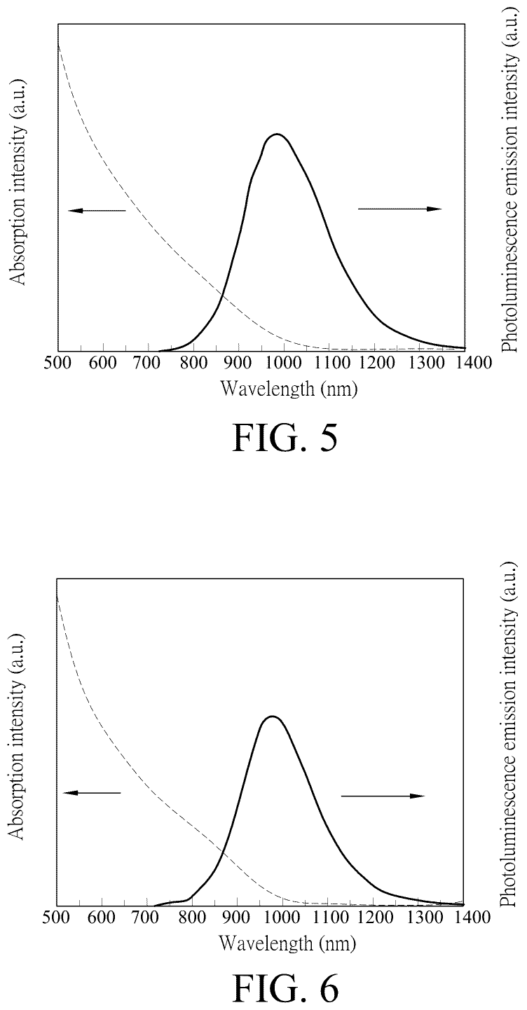

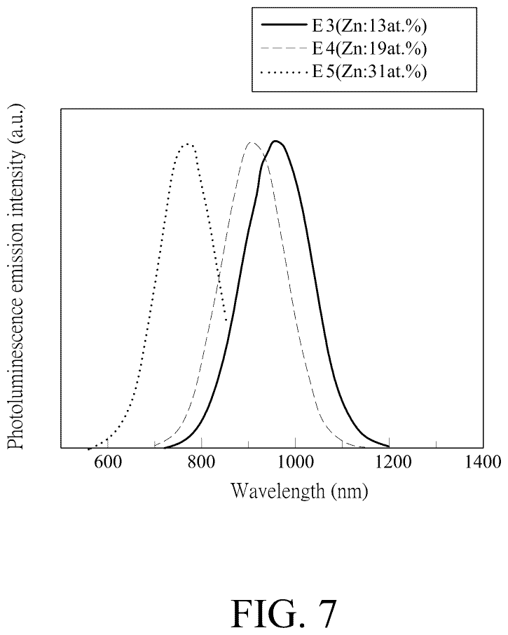

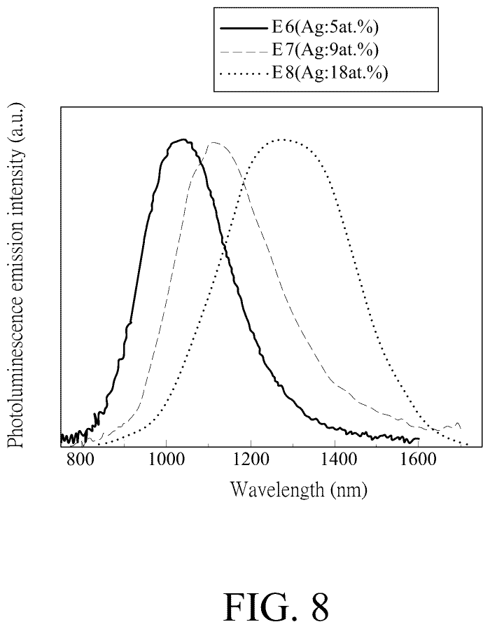

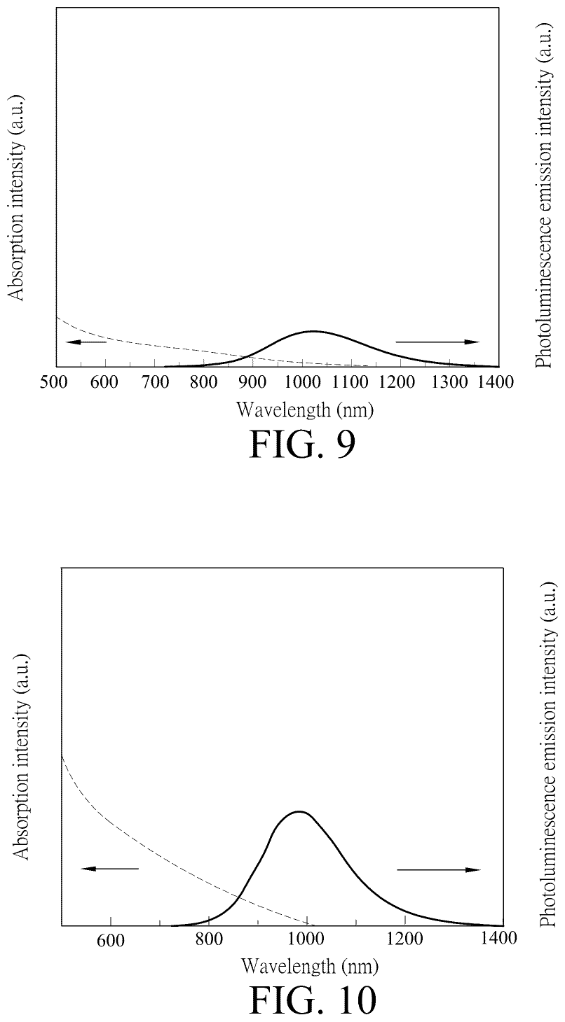

In addition, the quantum dots prepared in each of the aforementioned examples were dispersed in toluene, and then subjected to fluorescence spectroscopy measurement, so as to determine the photoluminescence quantum yields (PLQY %), PL peak and full width at half maximum (FWHM). The results were shown in Table 1. In addition, the fluorescent absorption/emission spectra of the quantum dots of the aforementioned examples were shown in FIGS. 5 to 10, in which FIGS. 5, 6, 9 and 10 are plots showing PL spectra and UV-vis absorption spectra of E1, E2, CE1 and CE2, respectively, while FIGS. 7 and 8 respectively show the PL spectra of E3 to E5 and E6 to E8.

TABLE 1

| | | Atomic percentage | | | |
|---|---|---|---|---|---|
| | | of doping material | | | |
| | | in nanocrystalline | PLQY | PL peak | FWHM |
| | Quantum dot | core (%) | (%) | (nm) | (nm) |
| E1 | Zn:CuInSeS/ZnS | Zn:8.2 | 98 | 982 | 188 |
| E2 | Zn:CuInSeS/ZnSeS | Zn:3.9 | 90 | 981 | 184 |
| E3 | Zn:CuInSeS/ZnS | Zn:13 | 85 | 954 | 173 |
| E4 | Zn:CuInSeS/ZnS | Zn:19 | 81 | 910 | 149 |
| E5 | Zn:CuInSeS/ZnS | Zn:31 | 84 | 766 | 150 |
| E6 | Ag/Zn:CuInSeS/ZnS | Ag:5 | 90 | 1047 | 243 |
| E7 | Ag/Zn:CuInSeS/ZnS | Ag:9 | 55 | 1110 | 269 |
| E8 | Ag/Zn:CuInSeS/ZnS | Ag:18 | 5 | 1260 | 343 |
| CE1 | CuInSeS | — | <1 | 1025 | 225 |
| CE2 | CuInSeS/ZnS | — | 60 | 981 | 198 |

As shown in Table 1, the quantum dots of E1 and E2 respectively had PLQY of 98% at the wavelength of 982 nm and PLQY of 90% at the wavelength of 981 nm, compared with that of a standard dye (IR125, PLQY=13% in ethanol; Rhodamine 101, PLQY=90% in ethanol), indicating they are capable of emitting near-infrared light. The PLQY of the quantum dots in E1 and E2 were much higher than those of the quantum dots in Juan Yang et al. (65%) and in CE2 (60%).

By comparing E1 with E3 to E5, it is noted that when the concentrations of the doping material (i.e., Zn) in the quantum dot was higher, the PL peak may shift to the shorter wavelength region, and the PLQY of the quantum dot may slightly decrease. Specifically, when the doping material is doped with an atomic percentage of not greater than 50% in the nanocrystalline core 2, the PLQY of the quantum dot may be greater than 70%. In particular, when the doping material is doped with an atomic percentage of not greater than 31% in the nanocrystalline core 2, the PLQY of the quantum dots may be not less than 81%.

Moreover, each of the quantum dots of E6 to E8 (doped with non-heavy metals, i.e., Ag and Zn) has the PL peak of greater than 1000 nm. Specifically, when Ag is doped with an atomic percentage of 5% in the nanocrystalline core 2, the quantum dot of E6 has the PL peak of 1047 nm, and the PLQY of 90%. In addition, when Ag is doped with an atomic percentage of 9% in the nanocrystalline core 2, the quantum dot of E6 has the PL peak of 1110 nm, and the PLQY of 55%. The PLQY of the quantum dots of E6 and E7 emitting at a long wavelength of greater than 1000 nm was significantly better than that of the conventional quantum dots emitting at the same wavelength. However, when the doping concentration of doping element (Ag) was too high (e.g., 18% for E8), the quantum dot of E8 may have a relatively low PLQY (5%) at the wavelength of 1260 nm since crystallographic defects (such as points defects, line defects and planar defects) may occur due to solid solubility limit of Ag atoms in CuInSeS quantum dots and since the size of Ag atoms is larger than other atoms in the quantum dots (e.g., Cu, In, and S). Therefore, when Ag is controlled to be doped with an atomic percentage of not greater than 10% in the nanocrystalline core 2, the Ag/Zn:CuInSeS/ZnS quantum dot may have the PLQY of not less than 50%.

In sum, by adding the thiol reagent to react with the core body before addition of the doping material, the nanocrystalline shell 3 can be grown slowly so as to form into a sphalerite-type (cubic) crystal structure, and the doping material is allowed to have more time to be distributed in the core body, such that the crystal structure of the core body can be transformed from an initial chalcopyrite-type (tetragonal) crystal structure to a sphalerite-type crystal structure due to the introduction of more defects by the doping material in the nanocrystalline core 2, thereby enhancing the PLQY of the quantum dot of this disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A quantum dot, comprising:
a nanocrystalline core including a core body and a doping material that is non-uniformly doped in said core body, said core body having a sphalerite-type crystal structure and including at least one element from Group IB, at least one element from Group IIIA, and at least one element from Group VIA, said doping material including at least one doping element selected from the group consisting of an element from Group IB, an element from Group IIB and an element from Group IIIA; and
a nanocrystalline shell surrounding said nanocrystalline core and including at least one element from Group VIA, and at least one element from one of Group IIB and Group IIIA.

2. The quantum dot according to claim 1, wherein said nanocrystalline core has a particle size within a range of 3 nm to 8 nm, and said nanocrystalline shell has a thickness within a range of 0.3 nm to 3 nm.

3. The quantum dot according to claim 2, wherein said core body includes a doped region that is doped by said doping material and that has a depth measured from an outer surface of said core body, said depth of said doped region being not less than 30% of a radius of said core body.

4. The quantum dot according to claim 1, wherein said core body is represented by a formula of CuInSeₓS₂₋ₓ, and said nanocrystalline shell is represented by a formula of ZnSe_{y}S_{1-y}, wherein 0≤x≤2 and 0≤y≤1.

5. The quantum dot according to claim 1, wherein said doping material includes at least one doping element from Group IIB which is present in an atomic percentage ranging from 1% to 50% in said nanocrystalline core, and said quantum dot has a photoluminescence wavelength that is not less than 700 nm and a photoluminescence quantum yield that is greater than 70%.

6. The quantum dot according to claim 5, wherein the atomic percentage of said at least one doping element in said nanocrystalline core ranges from 3% to 31%, and the photoluminescence quantum yield of said quantum dot is greater than 80%.

7. The quantum dot according to claim 1, wherein said doping material includes at least one doping element from Group IB which is present in an atomic percentage ranging from 1% to 10% in said nanocrystalline core, and said quantum dot has a photoluminescence wavelength that is greater than 1000 nm and a photoluminescence quantum yield that is greater than 50%.

8. The quantum dot according to claim 1, wherein said nanocrystalline shell has a sphalerite-type crystal structure.

9. A method for preparing a quantum dot of claim 1, comprising the steps of:
a) preparing a first solution which includes a salt of at least one element from Group IB, a salt of at least one element from Group IIIA, and a first coordinating solvent, preparing a second solution which includes at least one element from Group VIA, and a second coordinating solvent, and preparing a third solution which includes a salt of at least one doping element selected from the group consisting of an element from Group IB, an element from Group IIB and an element from Group IIIA, and a third coordinating solvent;
b) heating the first solution to a reaction temperature ranging from 160° C. to 220° C., and reacting therewith the second solution at the reaction temperature to obtain a nucleated solution, followed by heating the nucleated solution to a temperature ranging from 160° C. to 240° C., so as to obtain a crystallized solution;
c) adding a thiol reagent into the crystallized solution for reaction to proceed at a temperature ranging from 180° C. to 200° C., so as to obtain an intermediate reaction solution; and
d) adding the third solution into the intermediate reaction solution at a temperature ranging from 200° C. to 220° C., so as to obtain a solution containing the quantum dot.

10. The method according to claim 9, further comprising a step of purifying the quantum dot from the solution obtained in step d).

11. The method according to claim 9, wherein in step c), the thiol reagent has 8 to 16 carbon atoms.

12. The method according to claim 9, wherein in step a), each of the first coordinating solvent, the second coordinating solvent and the third coordinating solvent is independently selected from the group consisting of a thiol having 8 to 16 carbon atoms, a fatty acid having 12 to 18 carbon atoms, a fatty amine having 12 to 18 carbon atoms, an organophosphate, and combinations thereof.

13. The method according to claim 9, wherein in step a), at least one of the first solution, the second solution and the third solution further includes a non-coordinating solvent.

14. The method according to claim 13, wherein the non-coordinating solvent is selected from the group consisting of 1-octadecene, paraffin oil, and a combination thereof.

15. The method according to claim 9, wherein step a) is conducted under an inert gas atmosphere.

16. The method according to claim 9, wherein in step c), the thiol reagent is added at an addition rate that is not greater than one tenth of a total amount of the thiol reagent added in step c) per minute.

17. The method according to claim 9, wherein in step d), the third solution is stepwise added with a time interval of not shorter than 30 minutes.

18. The method according to claim 9, wherein in step a), the second solution includes a first sub-solution which includes an element from Group VIA in a first concentration and a second sub-solution which includes an element from Group VIA in a second concentration different from the first concentration.

19. The method according to claim 18, wherein in step b), the first sub-solution of the second solution is added to react with the heated first solution, and in step c), the second sub-solution of the second solution and the thiol reagent are added to the crystallized solution for reaction to proceed.
